(19) United States
(12) Patent Application Publication
(10) Pub. No.: US 2015/0153884 A1
(43) Pub. Date: Jun. 4, 2015

(54) FrameLess Tablet

(71) Applicants: Yonggui Li, Qingdao (CN); Kun Li, Qingdao (CN)

(72) Inventors: Yonggui Li, Qingdao (CN); Kun Li, Qingdao (CN)

(21) Appl. No.: 14/619,967

(22) Filed: Feb. 11, 2015

Related U.S. Application Data
(63) Continuation-in-part of application No. PCT/CN2013/084820, filed on Oct. 8, 2013.

(30) Foreign Application Priority Data
Apr. 25, 2013 (CN) 201310146247.X

(51) Int. Cl. G06F 3/041

(52) U.S. Cl. CPC G06F 3/0412

(57) ABSTRACT

This is a solution improving the frames of a tablet, a grip support-point, a grip hold-point and an anti-mis-touch shielding area are set on the touch screen of the tablet to form the holding positions of the tablet in order to narrow the frames of the tablet to become protective borders as small as possible, so as to reduce the size and the weight of the tablet. The grip hold-point is a soft shielding point on the touch screen, and generally, the grip hold-point automatically tracks into the touch point when the thumb of a hand holding the tablet touches the touch screen. The grip support-point is also a soft shielding point on the touch screen, and is always located at a point of the edges of the touch screen, and generally, the grip support-point automatically tracks into the touch point when the root bulge of the thumb of the hand holding the tablet contacts and presses a border of the tablet and touches the touch screen. The shape, size and position of the anti-mis-touch shielding area which is used for shielding common screen-touching operations, are determined according to the touching statuses and positions of the grip support-point and the grip hold-point.

### CROSS-REFERENCE TO RELATED APPLICATIONS

This application claims the benefit of PCT application No. PCT/CN2013/084820 filed on Oct. 8, 2013 and entitled with “Frameless Tablet”, and clams the priority benefit of China application No. 201310146247,X filed on Apr. 25, 2013 and entitled with “Frameless Tablet”.

### TECHNICAL FIELD

This invention is a frame solution used for a larger size handheld digital device like a tablet, etc.

### BACKGROUND ART

Now, the main problem of the frames of a tablet is that the frames are very wide to increase the size and weight of the tablet.

### BRIEF SUMMARY OF THE INVENTION

In order to solve the problem that the frames of a tablet are too wide, this solution narrows the frames of the tablet to become protective borders as narrow as possible by setting a grip support-point, a grip hold-point and an anti-mis-touch shielding area with the tablet. So, the display area of the tablet is larger than that of a common tablet with the same size, or the size and weight of the tablet both are smaller than that of a common tablet with the same display area. And moreover, the tablet has much more freedom of griping, and the grip positions are no longer just restricted to the frames.

### BRIEF DESCRIPTION OF THE DRAWINGS

FIG. 1 is the first diagrams of the frameless tablet;

FIG. 2 is the second diagrams of the frameless tablet;

FIG. 3 is the third diagrams of the frameless tablet.

### DETAILED DESCRIPTION OF THE INVENTION

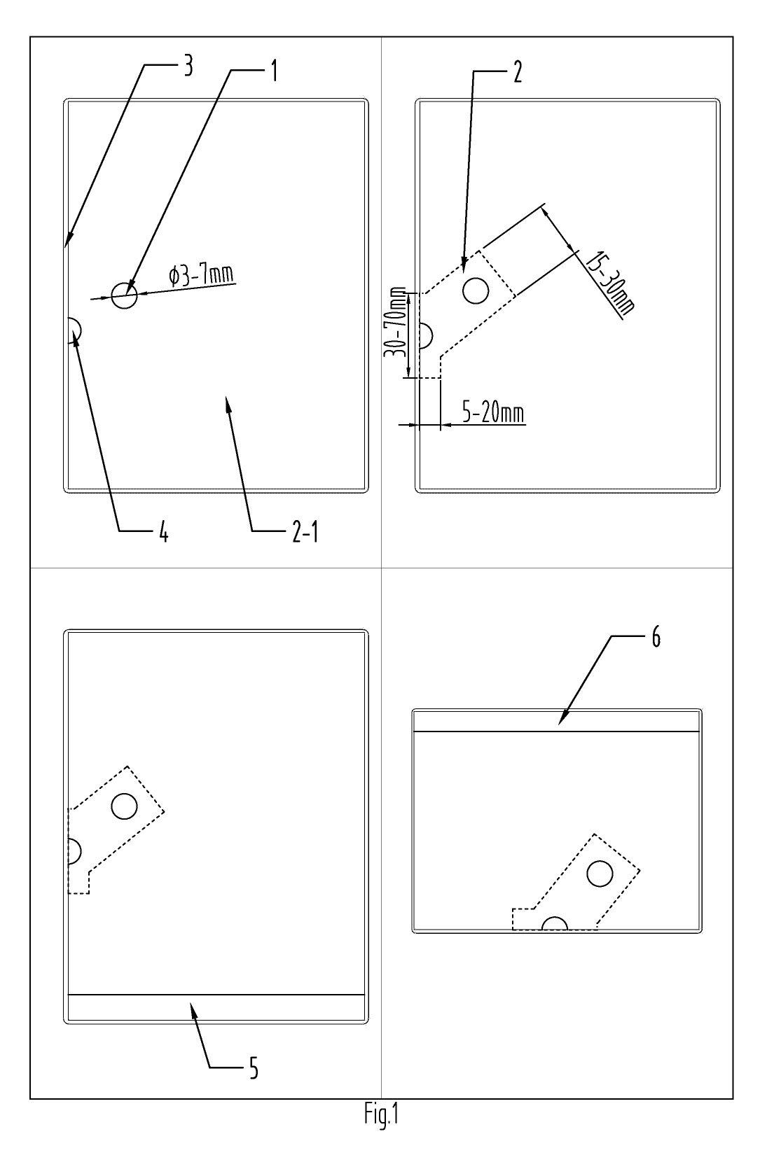

A grip support-point, a grip hold-point and an anti-mis-touch shielding area being set on the touch screen of a tablet as 1 and 4 in FIG. 1 narrow the frames of the tablet to become protective borders as narrow as possible as 3. This not only removes the redundant frames of the tablet, but also provides convenience for a user to grope a comfortable holding position.

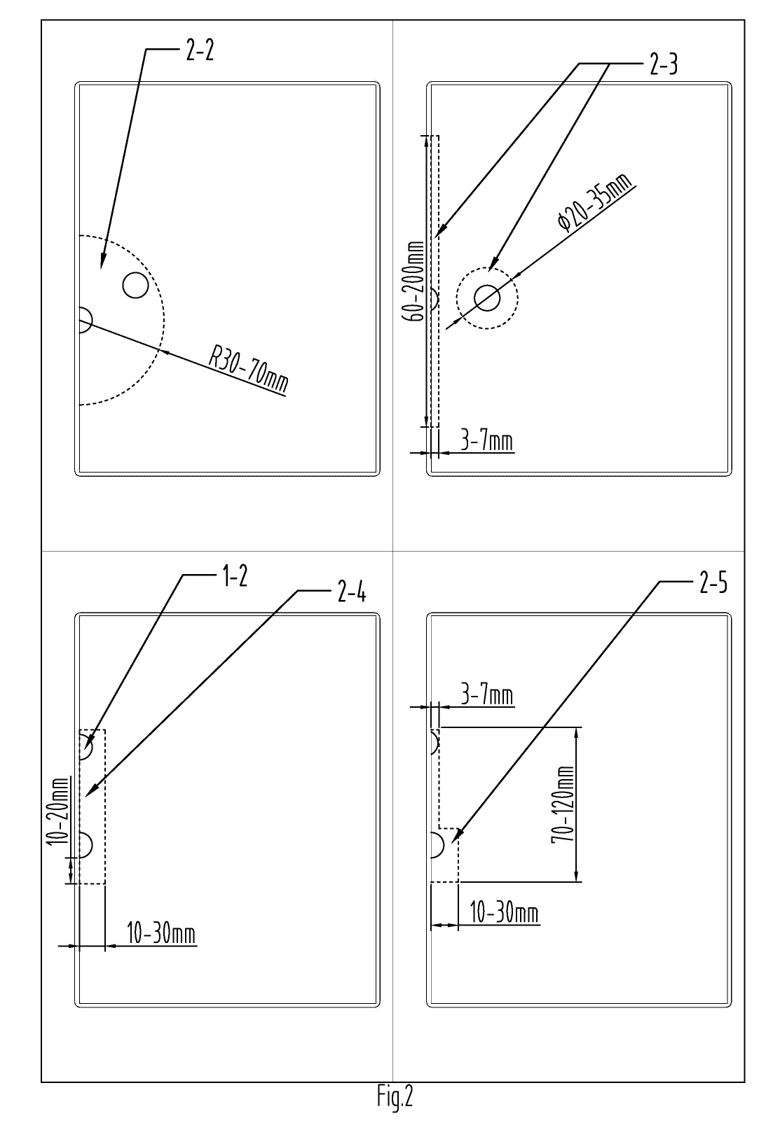

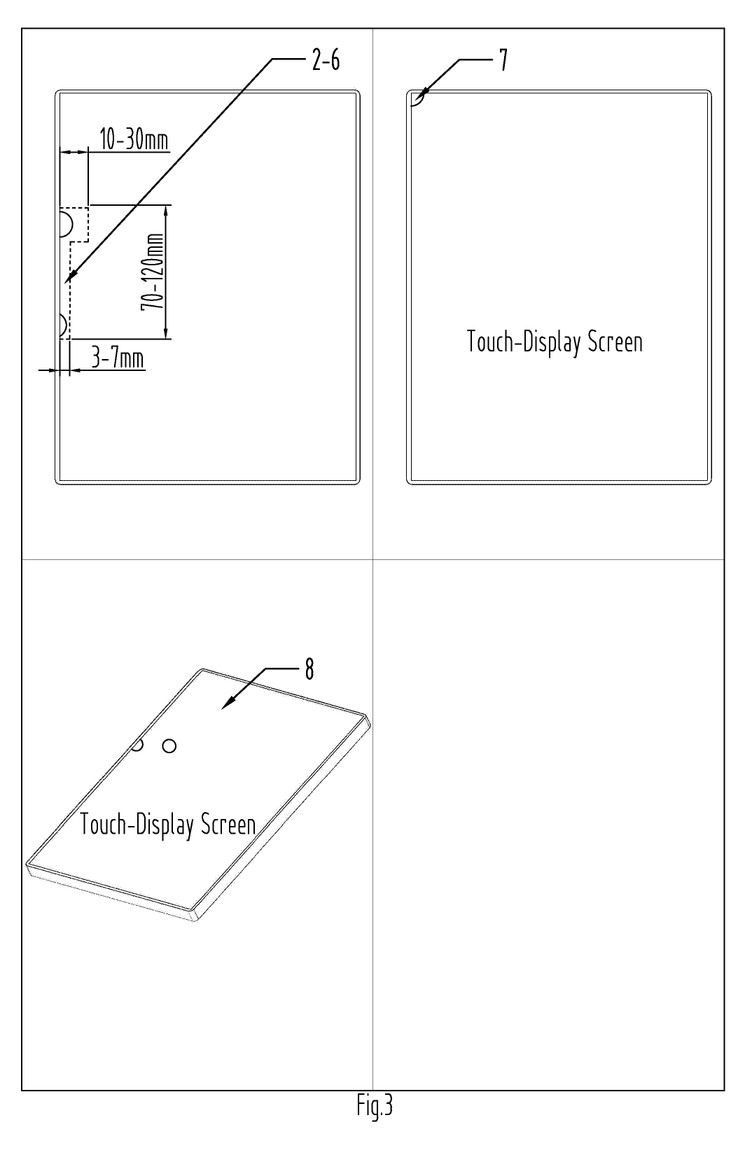

The grip hold-point as 1 in FIG. 1 is a soft shielding point on the touch screen. The point is a round button which had better have an about 3 to 7 mm long diameter. The grip hold-point shields the user interface elements of the touch screen under it and the touch actions on it like slide, one-click, double-click etc. are only used for the other purpose. The grip hold-point can be moved anywhere on the touch screen following the sliding of the finger touching the grip hold-point. The grip hold-point has an automatically tracking function, i.e., when the grip hold-point is in a released status, if a finger touches anywhere in the anti-mis-touch shielding area, the grip hold-point will automatically move into the touch point under the finger. And generally, the grip hold-point is touched and held by the thumb of a hand holding the tablet. The thumb can slide the grip hold-point, or release the grip hold-point first and then touch the touch screen at a proper position in the anti-mis-touch shielding area for the grip hold-point to automatically track the new touch point, or even dangle the thumb to release the grip hold-point, so that the user can change the holding gesture to a comfortable position or clear the touch area to operate or browser. If the user wants to use the thumb holding the tablet to perform common touch operations on the touch screen or to reduce the anti-mis-touch shielding area, the user can use the thumb to touch at a point along the edge of the touch screen, the grip hold-point accordingly docks along the edge as 1-2 in FIG. 2 and the anti-mis-touch shielding area like 2-4, 2-5 in FIG. 2 and 2-6 in FIG. 3 is reduced. Then the grip hold-point only automatically tracks touch points along the edge of the touch screen until it is slid off the edge and the whole of it is inside the touch screen again. If the grip hold-point is slid into a point along the edge of the touch screen, it had better not dock along the edge.

Grip support-point 4 in FIG. 1 is also a soft shielding point on the touch screen and always located at a point of the edges of the touch screen. It is a semicircle or sub-semicircle button shielding the user interface elements of the touch screen under it. And the touch actions on it like slide, one-click, double-click etc. are only used for the other purpose. The grip support-point is equivalent to or a little less than the grip hold-point in size. The graphic elements like color, opacity and hatch etc. can be different between the grip support-point and the grip hold-point. When a finger slides the grip support-point, the grip support-point moves following the movement of the finger. When the finger moving the support-point releases, if the support-point is not in an edge of the touch screen, it automatically docks at the nearest point of the nearest edge of the touch screen. When a finger touches at a point in the anti-mis-touch shielding area along an edge of the touch screen, the support-point automatically moves or tracks into the touch point under the touching finger. And generally, the grip support-point automatically tracks the touch point when the root bulge of the thumb of a hand holding the tablet contacts and presses a border of the tablet and touches the touch screen.

When the grip hold-point and the grip support-point automatically track, the tracking routes can be displayed via animation. When the touch screen goes on and there is not any touch and contact action on the touch screen, the initial positions of the grip support-point and the grip hold-point are as 1 and 4 in FIG. 1. They are about at the middle left and a little upper of the middle left of the tablet. If a user is a lefty, the grip support-point and the grip hold-point are at the middle right and a little upper of the middle right of the tablet.

An anti-mis-touch shielding area is configured as 2, 2-1 in FIG. 1 and 2-2, 2-3, 2-4, 2-5 in FIG. 2 and 2-6 in FIG. 3. The functions of the anti-mis-touch shielding area are A) shielding the user interface elements or common touch actions in the anti-mis-touch shielding area; B) confining the grip support-point and the grip hold-point in the anti-mis-touch shielding area; C) confining the automatically tracking functions of the grip support-point and the grip hold-point in the anti-mis-touch shielding area; D) shielding the extra touch actions produced by the fingerprint, palm print and knuckles etc. of the thumb and the root bulge of the thumb of a hand holding the tablet. The dashed lines of the anti-mis-touch shielding area do not exist actually on the touch screen and are only for illustration.

Different holding gestures have different anti-mis-touch shielding areas. 2 in FIG. 1 is the shape, position and size of the anti-mis-touch shielding area when the tablet is held at a side and the grip support-point and hold-point are both touched effectively and the whole grip hold-point is in the touch screen. This anti-mis-touch shielding area is formed by merging the rectangle able to cover the grip support-point and the grip hold-point and the rectangle able to fully shield the extra touch actions of the root bulge of the thumb of a hand holding the tablet together. The lengthwise midline of the previous rectangle which is a little wider than the thumb is coincident with the connecting line between the centers of the grip support-point and the grip hold-point. The midpoint of a long side of the latter rectangle which is coincident with a sideline of a border of the tablet is the center of the grip support-point, This rectangle is about 0.7 palm long and 0.8 thumb wide. The whole touch screen is the anti-mis-touch shielding area as 2-1 when the grip support-point and the grip hold-point are both released. When the grip support-point is touched and the grip hold-point is released, the anti-mis-touch shielding area is a semicircular area centered at the grip support-point with a one-thumb-long radius as 2-2 in FIG. 2. When the grip support-point is released and the grip hold-point is touched, the anti-mis-touch shielding area comprises a circle covering the grip hold-point and a rectangle containing the grip support-point as 2-3. The diameter of the circle is a little larger than the thumb's width. The midpoint of a long side of the rectangle is the pedal from the grip hold-point to the nearest sideline of the touch screen. The length of the rectangle is less than the width of two palm. When the grip support-point and hold-point are both touched and the grip hold-point docks along an edge of the touch screen, the anti-mis-touch shielding area is a rectangle covering the two points as 2-4. This rectangle should be a little longer at the end near the grip support-point. As shown in the figure, a surplus of 10 to 20 mm is given. And the rectangle is about a thumb wide. When the grip support-point is touched and the grip hold-point is released and docks along an edge, the anti-mis-touch shielding area is a combination of two rectangles as 2-5. The wider rectangle covering the grip support-point is about a thumb wide and should be a little longer at the end near the grip support-point. The narrower rectangle is longer than a thumb. When the grip support-point is released and the grip hold-point is touched and docks along an edge, the anti-mis-touch shielding area is a combination of two rectangles as 2-6 in FIG. 3. The wider rectangle covering the grip hold-point is about a thumb wide. The sum of the lengths of the two rectangles is a little longer than the sum of the length of a thumb and the length of the root bulge of the thumb. There are reference dimensions of various anti-mis-touch shielding areas in the drawings.

The released grip support-point or hold-point in the anti-mis-touch shielding area as 2-3, 2-5 and 2-6 can be smaller than a semicircle. In the anti-mis-touch shielding area as 2-4, 2-5 and 2-6, the grip hold-point only automatically tracks the touch point of the finger touching along the edges of the touch screen. Of course, a user can move the grip hold-point to anywhere either along or off the edges by sliding it with the thumb. When the grip hold-point leaves an edge of the touch screen to be inside the touch screen completely and is released, it restores the function to automatically track anywhere in the anti-mis-touch shielding area as 2-1 in FIG. 1 and 2-2 in FIG. 2. In any cases, after the grip support-point and hold-point are both released for a reasonable delay, the grip support-point, the grip hold-point and the anti-mis-touch shielding area all restore the initial state as 1 in FIG. 1, i.e., the whole touch screen is the anti-mis-touch shielding area. The above-mentioned delay is in order to prevent the grip support-point or/and hold-point from being touched in vain for the time being.

When the tablet does not require to be held by hand, for example, when the tablet will be put up by a support, a user can double-click or one-click on the grip support-point in order that the grip support-point absorbs the grip hold-point and then automatically docks at a default position e.g. 7 in FIG. 3 on the touch screen and the anti-mis-touch shielding area is disabled at the same time. At this time, the grip hold-point disappears and the whole touch screen restores common touch function except at the grip support-point which is one-fourth the size of the original or even smaller right now. When the grip support-point and hold-point need to be enabled again, slide the grip support-point which has absorbed the grip hold-point and is docking at a corner as 7 in FIG. 3 or along a sideline off the corner or the sideline, the grip support-point breaks up into the grip support-point and the grip hold-point again, and then the grip support-point, the grip hold-point and the anti-mis-touch shielding area restore the initial state as 1 in FIG. l. The grip support-point located at 7 in FIG. 3 can also be moved to the other proper position along the sidelines of the touch screen by a finger. And generally, the grip support-point had better dock at a corner. The system comprising a grip support-point, a grip hold-point and an anti-mis-touch shielding area is an independent one. This system and common touch operations including common multi-touch operations outside the anti-mis-touch shielding area do not interfere with one another.

If a tablet has a task bar or the similar user interface element, in order to avoid mutual interference between the anti-mis-touch shielding area and the task bar, when the tablet is held at a side, the task bar should be put at the bottom as 5 in FIG. 1 or top or the other side of the tablet, but when the tablet is held at the bottom, the task bar should be put at the top as 6 in FIG. 1 or left or right of the tablet.

When the grip support-point or the grip support-point and the grip hold-point both is/are not touched for a long time, the buttons of the grip support-point and hold-point should automatically hide. When there is a screen-touching action, the buttons of the grip support-point and hold-point are enabled and appear again. All of screen-touching actions are shielded before the grip support-point and hold-point are enabled.

The buttons of the grip support-point and hold-point should be light-colored, transparent, small and not prominent as far as possible in order not to influence the beautiful and harmonious user interface of the tablet. Of course, the settings of color depth, transparency, hatch density and hiding delay etc. of the buttons can also be provided for a user to get a better use experience.

Double-click, one-click and three-click on the anti-mis-touch shielding area or the grip support-point having absorbed the grip hold-point are used for acting as HOME, BACK and RECENT buttons or for the other purposes. And sliding the grip hold-point is used for swiping the screen of the tablet or for the other purposes. The grip support-point, the grip hold-point and the anti-mis-touch shielding area can also be set on the touch screen of a wide frame tablet only for a better holding comfort.

8 in FIG. 3 is a stereo view of the frameless tablet.

The dimensions marked in the drawings and given in this description cannot be regarded as limitations to this invention. Obviously, the other proper and useful dimensions should be treated as part of this invention.

Because the frames are narrowed and the force point of the grip hold-point is right on the touch screen, the design, technics and material strength of the narrow borders and the back supporting structure of the touch screen should be enhanced in order not to weaken the whole structure strength of the tablet from narrowing the frames. Of course, the strength of the touch screen itself should also be enhanced.

1. A frameless tablet, comprising
1) a grip hold-point which is a soft shielding point on the touch screen and generally automatically tracks into the touch point when the thumb of a hand holding the tablet touches the touch screen;
2) a grip support-point which is also a soft shielding point on the touch screen and always located at a point along the edges of the touch screen and generally automatically tracks into the touch point when the root bulge of the thumb of the hand holding the tablet contacts and presses a border of the tablet and touches the touch screen;
3) an anti-mis-touch shielding area which shields common screen-touching operations and which shape, size and position are determined according to the touching statuses and positions of the grip support-point and the grip hold-point;
and the grip hold-point, the grip support-point and the anti-mis-touch shielding area together form the holding positions of the tablet.
